(19) United States
(12) Patent Application Publication
(10) Pub. No.: US 2004/0133593 A1
(43) Pub. Date: Jul. 8, 2004

(54) E-maintenance system

(75) Inventors: Nilesh Pathak, South Harrow (GB); Hideki Hazehara, Harrow (GB)

Correspondence Address: FITZPATRICK CELLA HARPER & SCINTO, 30 ROCKEFELLER PLAZA, NEW YORK, NY, 10112, US

(73) Assignee: CANON EUROPA NV, AMSTELVEEN (NL)

(21) Appl. No.: 10/695,915

(22) Filed: Oct. 30, 2003

(30) Foreign Application Priority Data
Nov. 1, 2002 (GB) 0225509.9

(51) Int. Cl. G06F 17/00

(52) U.S. Cl. 707/103 R

(57) ABSTRACT

A central server (50) of an e-maintenance system is provided to receive status information from a plurality of electronic devices (26, 28, 30, 32, 34, 36, 38, 40, 42, 44, 46 and 48) such as photocopiers, printers and scanners that require maintenance from time to time. If appropriate, the central server then sends a message to a maintenance organisation (52) relevant to a particular one of said devices, for example reporting that a fault has occurred with that device. The message enables the maintenance organisation to obtain status information relating to that device from the central server.

The present invention relates to the remote maintenance of electronic devices.

It is known to provide maintenance for electronic devices, such as printers, photocopiers, scanners and the like. In an office environment, there may be a number of such devices and one or more maintenance companies providing maintenance services for those devices. When a problem with one of those devices that requires expert assistance is identified, a service call is made to the relevant maintenance company.

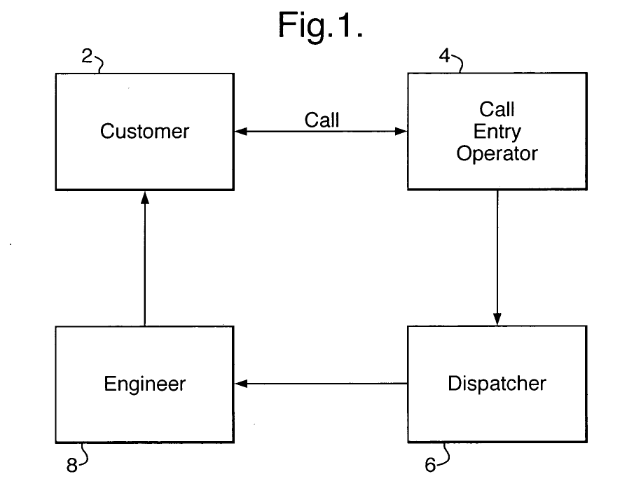

FIG. 1 shows a typical arrangement for handling service calls. The arrangement of FIG. 1 comprises a customer 2, a call entry operator 4, a dispatcher 6 and an engineer 8.

The customer 2 reports a problem with an electronic device to the call entry operator 4 by making a telephone call. For example, the customer may report that a photocopier has stopped working and is displaying a certain error message. The call entry operator 4 logs the call, recording information such as the name of the caller, the identity of the faulty device and a description of the fault, including noting the error message. A job reference may be given to the caller.

The information recorded by the call entry operator 4 is logged on a database. The database is accessed by a dispatcher 6. The dispatcher assesses the fault and takes the appropriate action. The action required may be explaining to the customer 2 how they can correct the fault themselves. Alternatively, the action required may be to send an engineer 8 to the customer. The dispatcher 6 may be the same person as the call entry operator 4.

A problem with the service arrangement of FIG. 1 is that assistance is provided to the customer only after a fault has been detected by the customer 2 and reported to the call entry operator 4. There will inevitably be a delay before the problem is reported and a further delay before the problem can be tackled, for example the time that it takes for the engineer 8 to get to the customer 2. During this time, the device is likely to be unusable.

A further problem with the service arrangement of FIG. 1 is that the customer 2 can only report faults after they have occurred. The customer 2 has no means of monitoring potential faults. If a fault can be predicted and action taken before it occurs, this can prevent the device from being out of order. Further, by dealing with faults before they happen, the sometimes destructive nature of faults such as paper jams can be avoided. This cost involved in repairing damaged devices may be significantly higher than preventing the fault from happening at all.

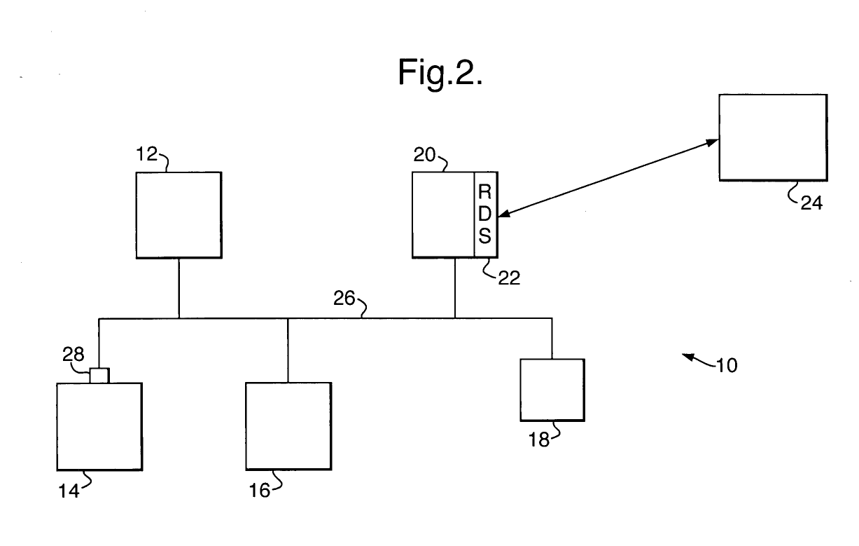

FIG. 2 shows a known maintenance system, indicated generally by the reference numeral 10, that has been developed to address the problems identified above. The system includes first, second and third electronic devices 12, 14 and 16. These devices may be photocopiers, printers, scanners or the like. The system also includes a client computer 18 and a server computer 20. Remote diagnostic software 22 is associated with the server computer 20. Remote diagnostic software 22 will be referred to hereafter by the abbreviation RDS. The server 20 is electronically linked to a remote backend 24, also termed a service management computer system.

Electronic devices 12, 14 and 16, client computer 18 and server 20 are all connected using a local network bus 26. Information regarding the status of devices 12, 14 and 16 is collected from those devices by the server 20. On the basis of this information, and under the control of RDS 22, the server 20 communicates with client computer 18 and backend 24.

The backend 24 is the organisation responsible for the maintenance of the devices 12, 14 and 16. The backend 24 takes the data provided by RDS 22 and can initiate action in response. Thus the backend 24 carries out the functions of the call entry operator 4 and the dispatcher 6 of FIG. 1 without the need for a customer to make a call to a call entry operator.

In the example of FIG. 2, the devices 12 and 16 are digital devices that are capable of providing digital status information which can be collected over the bus 26. In practice the transmission of the status information is in response to the devices being polled by the RDS. Device 14 is an analogue device that does not have this capability. Device 14 is provided with a Direct Access Unit 28 that converts analogue information regarding the status of device 14 into digital data that can be accessed through the bus 26.

Data that can be collected over the bus 26 includes indications of paper and toner levels, paper jams, errors or alarms, parts counters, paper usage information, device usage information, hardware installed on the device (e.g. document feeders) and software installed on the device.

The RDS performs a number of functions. These include: monitoring the status of the devices it is connected to, storing data regarding those devices for analysis, alerting the customer and/or the backend of problems and potential problems and tracking the usage of consumables such as paper and toner.

The RDS 22 can transmit data to the backend 24 under two different conditions: either as event data or as scheduled data. Event data is sent either as soon as the RDS has detected the event or as soon as certain conditions or thresholds have been met. Scheduled data is sent at regular intervals, such as weekly (e.g. 00:30 on every Monday) or monthly (e.g. 00:30 on the 28th day of each calendar month).

Scheduled information that might be gathered includes information concerning, for example, the expected life of parts within the devices.

Considering event data first, the RDS 22 handles different classes of events in different ways. The most serious events are ones that prevent a device from working and are termed “errors”. Serious events that do not prevent a device from working cause an “alarm”. An “alarm” can be serious in nature and requires immediate notification to the backend 24; it can also be less serious in nature but likely to recur. For instance, an error might be a paper jam and an alarm might be toner low indication.

The RDS monitors each of devices 12, 14 and 16 and, if any of those devices stops working, an error has been identified. When the RDS detects an error, both the client computer 18 and the backend 24 are informed. (Note that the client and server computers here may be one and the same.) There are essentially two types of error: ones that can be fixed by the customer and ones that require an engineer to be called. The response to an error is determined by the backend 24. On receiving an error message, the status of the relevant device can be reviewed and the appropriate action taken. This may require sending an engineer to the device or it may require contacting the customer to talk them through a procedure that they can carry out themselves. Whichever option is implemented, the initiative can be taken by the backend 24, rather than waiting for the customer to notice the error.

The RDS also monitors devices 12, 14 and 16 for serious or potentially serious events that do not prevent a device from functioning. As noted above, such events are termed alarm conditions. When the RDS detects an alarm condition, the backend 24 is informed but the customer is not informed. This is because the particular device is still working and the client does not need to be made aware that there may be a problem. The appropriate action can be taken at the backend 24 as described above before the customer is aware that there is a problem. This may lead to potentially serious faults being prevented with the minimum of downtime of the device concerned.

The use of the RDS enables a maintenance department to take action proactively. For example, alarm conditions may indicate that a problem is likely to occur in the near future. Maintenance action can be carried out before a problem occurs, resulting in less downtime and less damage to machinery.

The system described above works well when there is only one backend. However, this is not always the case. There may be a number of different maintenance organisations supporting the various customers of the system. Different organisations are likely to have different service backends, (or “service management system(s)” as they will be termed hereinafter).

In such case, every different service management systems needs to be modified and to be provided with a special application, so that the service management systems can understand and store data sent by a RDS.

This is possible but potentially expensive.

Such a problem exists where a maintenance system is implemented across a number of countries, with at least one different service management system being provided for each country.

Further within each service management system it would be necessary to handle the data received from the RDS's (for example store it in a database or take action based upon it). This would multiply the cost.

It is an object of the present invention to provide an electronic maintenance system that addresses at least some of the above-mentioned problems.

The present invention provides a remote maintenance data system comprising a central server, the central server comprising:

a receiving means arranged in the central server to receive status information about a plurality of electronic devices that from time to time require maintenance, that status information being transmitted from the devices to the central server directly or via one or more intermediary devices, the transmission of the status information being initiated by the devices and/or the intermediary devices; and

a sending means arranged in the central server to send a message, based on the status information, to an entity relevant to a particular electronic device, that enables the entity to obtain from the central server status information about the device.

The present invention also provides a method of interfacing a plurality of electronic devices that from time to time require maintenance, comprising:

transmitting status information from the device to a central server, directly or via one or more intermediary devices; and

transmitting a message, to an entity relevant to a particular electronic device, that enables the entity to obtain from the central server status information about the device,

wherein the transmission of the status information is initiated by the devices and/or the intermediary devices.

Since the sending of data to the central server is initiated by the device itself (or by an intermediary device), the system does not need to wait for the user to notice that there is a problem. Thus, a maintenance organisation can be proactive in dealing with actual or potential problems with a device, rather than reacting to customer complaints.

Status information may be transmitted by email, with the receiving and sending means of the maintenance system being mail servers. This provides a simple communication system that can be used to overcome interfacing problems between different systems.

The present invention further provides a remote maintenance data system comprising:

a central server arranged to receive status information about a plurality of electronic devices that from time to time require maintenance, that status information being transmitted from the devices to the central server directly or via one or more intermediary devices; and

a web server arranged to communicate with the central server,

wherein:

the central server is further arranged to send a message containing information based on the status information to an entity relevant to a particular electronic device, said message comprising a hypertext link; and

the said web server, having access to at least the status information relevant to the particular electronic device, is arranged to respond to the said link being activated to provide the said status information.

The present invention also method of interfacing a plurality of electronic devices that from time to time require maintenance, comprising:

transmitting status information from the device to a central server, directly or via one or more intermediary devices; and

transmitting a message, to an entity relevant to a particular electronic device, that enables the entity to obtain from the central server status information about the device,

wherein the transmission of the status information is initiated by the devices and/or the intermediary devices.

Providing a message with a hypertext link is a very simple way if interfacing between different systems. The message can be readily generated by a mail server at the central server and the entity to which it is sent can readily activate the hypertext link to access the detailed status information that may be required to ascertain the nature of a problem with a device. This mechanism reduces problems that can be encountered when different maintenance organisations, with different data and control systems, are all linked to a central server.

By way of example only, embodiments of the present invention will now be described with reference to the accompanying drawings, of which:

FIG. 1 shows an arrangement for handling service calls.

FIG. 2 shows a known maintenance system,

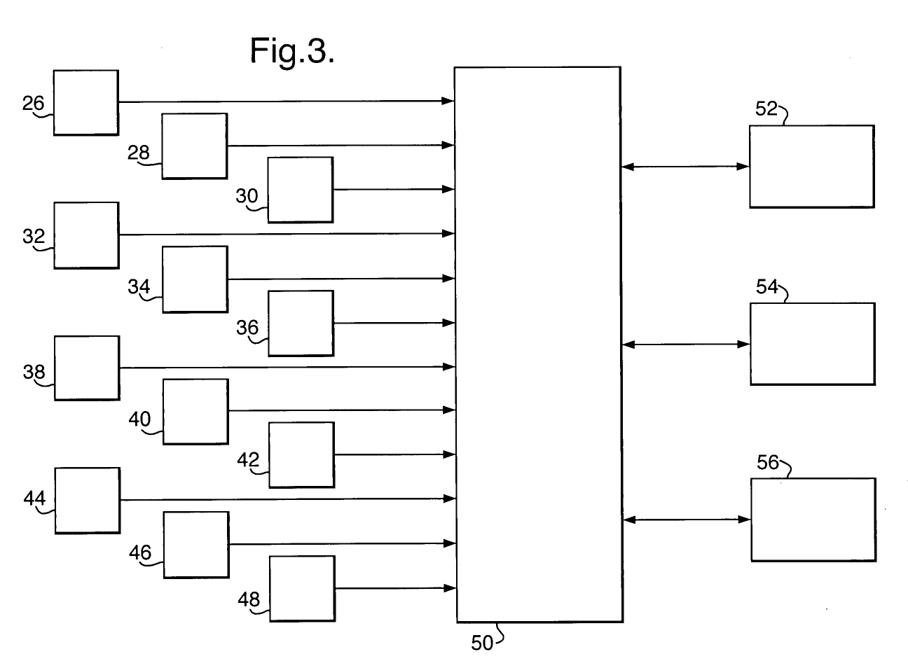

FIG. 3 shows a maintenance system having a central server,

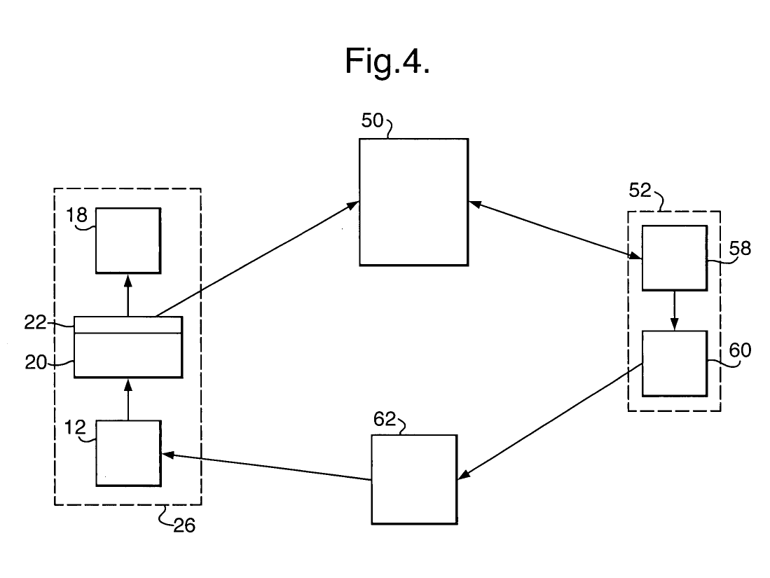

FIG. 4 shows how a fault is dealt with,

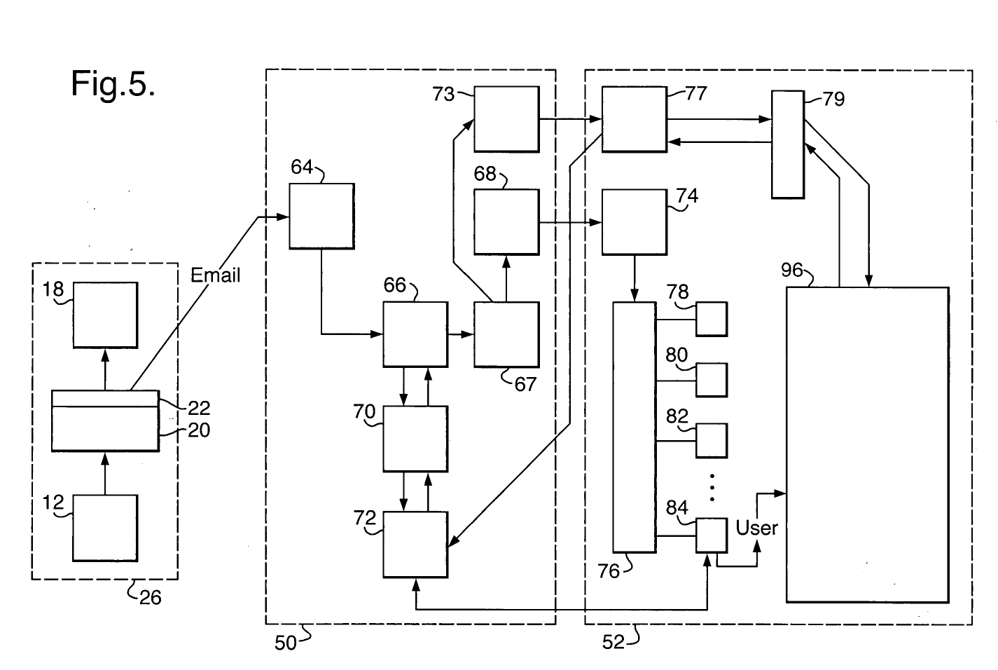

FIG. 5 shows further details of the maintenance system, and

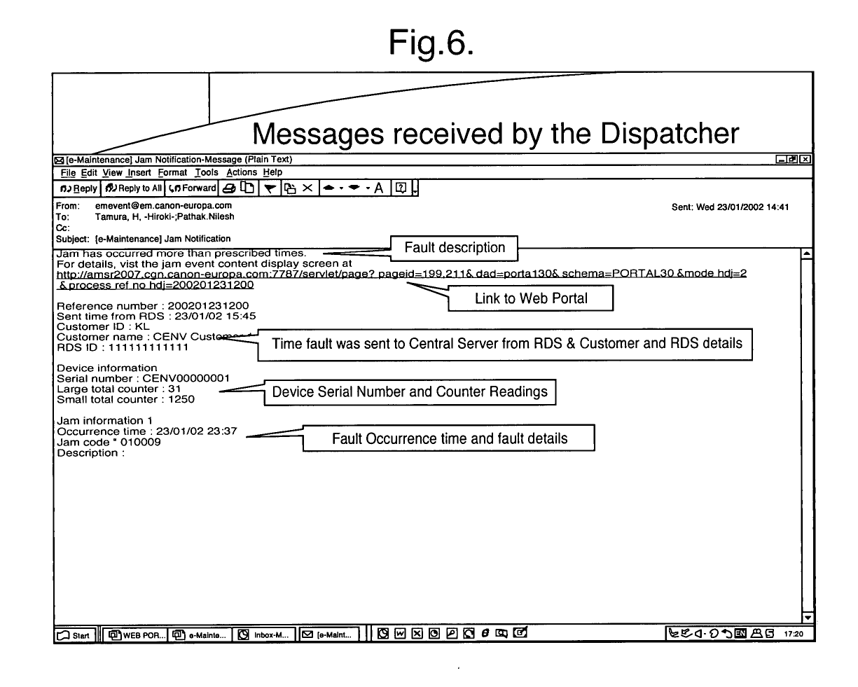

FIG. 6 shows an example of an email message sent to a user.

FIG. 3 shows a system according to the present invention having a plurality of clients 26, 28, 30, 32, 34, 36, 38, 40, 42, 44, 46 and 48, and a plurality of maintenance organisations 52, 54, 56. Each client communicates with a central server 50 and the central server communicates with each of the maintenance organisations 52, 54 and 56. Each client is associated with at least one maintenance organisation and each client communicates with the appropriate maintenance organisation via the server 50. A client could, if it were desired transmit different kinds of event or scheduled data to different maintenance organisations or indeed communicate with different maintenance organisations in respect of different devices.

Refer to FIGS. 2 and 3. Each of the plurality of clients 26, 28, 30, 32, 34, 36, 38, 40, 42, 44, 46 and 48 may include electrical devices such as devices 12, 14 and 16 of FIG. 2 and may include a client computer 18 and a server 20 including RDS 22. The backend 24 of FIG. 1 corresponds to the maintenance organisation with which the client is associated. The central server 50 is the means through which the client communicates with the maintenance organisation.

FIG. 4 demonstrates how a fault with a device 12 is dealt with using the system of the present invention. FIG. 4 shows a client 26, including an electrical device 12, a client computer 18 and a server 20 having RDS 22, as in the example of FIG. 2. Client 26 communicates with an maintenance organisation 52, including an maintenance organisation call centre 58 and a dispatch system 60, via central server 50. Dispatch system 60 communicates with an engineer 62. The engineer 62 can visit the client to repair faulty device 12.

RDS 22 monitors device 12 as outlined above. When a fault is detected, the relevant maintenance organisation is informed, via server 50 by RDS 22. The client computer 18 may also be informed, depending on the type of fault, as described above. At the maintenance organisation, a call centre 58 logs the call and a dispatch 60 takes the necessary action. This action may require dispatching an engineer 62 to the site.

Data may be transferred from RDS 22 to central server 50 in a number of ways, for example, TCP/IP or email over the Internet or using a direct telephone connection or a wireless connection. The example below assumes that email is used.

FIG. 5 shows in more detail the system by which a client 26 communicates with a maintenance organisation 52 via central server 50. The client 26 comprises an electrical device 12, a client computer 18 and a server 20 having RDS 22, as in FIGS. 2 and 4. Central server 50 comprises a first mail server 64, a parser 66, a message composer 67, a second mail server 68, a database 70, a web portal 72 and an MQ mail server 73. Maintenance organisation 52 comprises a mail server 74, server network 76, an MQ mail server 77 a bridging system 79, and service management system (SMS) 96.

When RDS 22 wishes to communicate with maintenance organisation 52, RDS 22 transmits an email to the first mail server 64 of central server 50. The email received by first mail server 64 is parsed by parser 66 before being passed to second mail server 68 (via message composer 67) and to database 70. A second email is sent from the second mail server 68 of the central server 50 to the mail server 74 of maintenance organisation 52. From mail server 74, the information is passed to maintenance organisation server network 76 from where it can be accessed via any one of terminals 78, 80, 82 and 84. A user working at one of terminals 78, 80, 82 and 84 (terminal 84 in the example of FIG. 5) transfers the information displayed at that server terminal to service management system 96. (The service management system can contain information about the clients electronic devices, parts, consumables, engineer availability, and so on.) The service management system implements the action to be taken in order to solve the problem, which has caused the sending of a message to the maintenance organisation (e.g. the dispatch of an engineer as required to the client's site).

The user at the maintenance organisation could have access to two separate data systems: that provided by the central server 50 and the maintenance organisation's local service management system 96. Of course a user could have a single terminal running separate programs to access the data from the two systems.

In the example, the user accesses information from the central server 50 using an email client to read messages sent to the mail server 74 by the central server 50. The user needs to be able to take possession of the problem and can obtain all the necessary details from the central server by means of the web portal 72.

Using this architecture the problem of providing separate electronic RDS to service management system interfaces for each maintenance organisation has been avoided while the users at the maintenance organisation have access to information from the RDS's 22 (via the central server 50).

Further the interface provided is quite simple and so is easily supported by the systems of any service organisation. Moreover all the information about the electronic devices and their faults is contained in the central server, as certain functionality in the service management system is not available to correctly support all the data obtained from the RDS.

Further details of the operation of the example system of FIG. 5 are as follows.

As stated above, in the example of FIG. 5, when RDS 22 wishes to communicate with maintenance organisation 52, an email is sent from RDS 22 to the first mail server 64 of the central server 50. That email consists of a main body and an attachment. The main body of the email sent from RDS to mail server 64 identifies the RDS in question and gives only general coded information regarding the data that is being transmitted. The data itself is contained within the attachment.

Communication between RDS 22 and mail server 64 is one-way, except for the transmission of an acknowledgement signal from the mail server 64 to RDS 22. (If no acknowledgement is received the RDS will attempt to send the message again at a later time.)

Mail server 64 passes the data included in the attachment to the email to parser 66. The data is parsed and the parsed data is stored in database 70. The information is also composed (by message composer 67) into a new email message, which is passed to second mail server 68, which relays it to the relevant maintenance organisation. Which maintenance organisation is relevant can be determined from information in the database, usually from the RDS concerned being explicitly recorded as being the responsibility of that maintenance organisation. However the relevant maintenance organisation can be determined from information in the message from the RDS (which can be included in the address to which it is sent) as is described later.

Event data received is relayed immediately to the maintenance organisations.

In another embodiment, some of the event data may simply be stored in the database and be delayed for some time. They could be collected up with other event data before being relayed.

In another embodiment, a maintenance organisation is informed about event data only once certain conditions are met. The conditions can be defined as parameters stored in the database. For instance, a “consumables replacement” event signalling that a consumable (such as a toner) has been replaced, is transferred immediately to the central server 50. In case the user has a stock of consumables, the maintenance organisation may want to receive a message, only when the stock has reached a critical level.

Therefore, the central server 50 stores all “consumables replacement” events relating to a same RDS in the database and sends a message to the relevant maintenance organisation once it has received a certain number of “consumable replacement” events. In this preferred example, the condition can be defined in the database as a threshold value specifying how many “consumable replacement” events the central server should have received from a same RDS before informing the relevant organisation.

Maintenance organisations, in this embodiment, are not jammed with messages which do not require immediate actions. The central server allows the maintenance organisations to be informed only when immediate actions are required.

Received scheduled data are transferred out again immediately or on a schedule depending on the choice of the maintenance organization.

The central server also checks emails from the RDS's. These mails are encrypted for security. They are checked to see if the RDS identity number is correct and also to see if the identify of the electronic device to which they refer is correct. The server also checks that it is receiving data from the RDS's as expected; if not it notifies the relevant maintenance organisation and the administrator of the central server.

The message sent to the maintenance organisation preferably contains more information than was included in the original message from the RDS. This supplementary information is added by the central server from its database. An example of such a message is shown in FIG. 6. This supplementary information may be a natural language version of information encoded in the original information (for example, an explanation of a fault code) or it may be some additional associated information (for example the RDS reports a fault with a particular device, the central server's database has recorded in it the fact that that device is located at a particular client's site, and the name of that client is added to the message sent to the maintenance organisation).

Further the message to the maintenance organisation may be adapted to the particular maintenance organisation. For example, it may be presented in an appropriate language, for example English or Portuguese etc.

As will be seen from FIG. 6, the message sent to the maintenance organisation is a notification that preferably contains little data. The user at the maintenance organisation accesses fuller information relevant to the fault reported by accessing the hypertext link in the message. Activating this link retrieves the fuller information from the web portal 72 of the central server 50. The web page is compiled at the same time as the message to the maintenance organisation but could be composed on the fly. The basic data about the fault was stored, as noted above, into the database by the parser 66 when the original message was received from the RDS. The web portal provides not only that information but also supplementary information, which may for instance include the name and address of the client, details of the particular device, which may be parts counters, logs of faults on the particular machine or part numbers and descriptions parts that may be faulty in this case, consumables required, etc.

The web portal of the central server, in this preferred example, provides a simple status recoding system for the fault messages sent to the maintenance organisation. Either on clicking the link in the message (FIG. 6), or by following subsequent links in the pages provided by the web portal, the user at the maintenance organisation can reach a page where they can record the handling status of the received message. Preferably the values the user can record for this are “not handled”, “handling” or “handled and dispatched” or “handled not dispatched”. On another page the web portal provides lists (filtered by status or complete) of the messages sent to a particular maintenance organisation and their status, to enable the users or their supervisor at the maintenance organisation to see what work is outstanding and as a check that all the sent messages have been received. If desired the web portal can also provide a page to a client of its faults and their handling status so that they may be reassured that the maintenance organisation has received a report of a fault at their site.

The web portal also allows (whether by starting at the link in the email of FIG. 6 or otherwise) access to a device report (for the device with the alert). This report contains relevant details about the device including what it is and what options it has fitted and its history of alerts and alarms and of maintenance carried out. Further the web portal also allows access to a “pre-maintenance” report about other devices at the site (i.e. usually having the same RDS) listing historical faults with them or suggesting other maintenance or part replacement that may be timely.

The supplementary data provided by the central server (in both the messages sent to the maintenance organisation and via the web portal) has of course to be provided to the central server. The data can be keyed into the web portal by a user at the maintenance organisation, or by an installation engineer on site, for example. This could occur for example when there is a new client or device to be included, or to set up or modify conditions indicating when a maintenance organisation should be informed about event data or about scheduled messages. For someone entering details (e.g. of a new device) on site an alternative is that the data is keyed into a user interface to the RDS which then transmits a special email to the central server which then records the information in its database.

Existing data can also be exported from the service management system and imported into the central server. Files of such export data can be uploaded to the web portal by MQ mail server 77 or other interfacing technologies using data format protocol such as XML, SOAP, emails, etc. The bridging system 79 provides the data conversion. Alternatively the bridging system may convert the data to XML format and upload that to the web portal.

The mechanism described above for notifying the maintenance organisations of faults (events) is to email the users (standard SMTP email is used), to alert them and to give them access to fuller information on the web portal. Another mechanism is to send data using MQ servers 73 and 77 (or other equivalent technology) to the bridging system 79 at the maintenance organisation (preferably by MQ email or other format such XML, flat file emails), which converts the data and imports it into the service management system. In the preferred embodiment a combination of those two mechanisms are used. For faults (events) the user at the maintenance organisation is sent an email to alert them of the problem, while scheduled transmissions can possibly be sent by MQ mail and the information is automatically imported to the maintenance organisation's service management system.

The details of such exports/imports may be specific to the particular service management system but is generally a simpler task than directly interfacing the RDS to the SMS as the invention seeks to avoid. This is because it is simply a data conversion exercise rather than having to dynamically respond to the various types of messages sent by the RDS. The central server could have the ability to interface with the maintenance organisation system and transmit necessary data depending on the interface between the central server and the maintenance organisation

The mail server 64 has different email addresses to which the RDS sends alerts and scheduled reports. Scheduled report messages are processed when there are no alerts waiting to be processed. This facilitates the different processing that alerts and scheduled transmissions receive (namely immediate email mailing to the maintenance organisation and scheduled transmission by MQ mail or other format such as XML respectively). It can also be used to facilitate the server giving first priority to alert messages. Scheduled messages are also stored in the central server database.

Server 64 preferably also provides different email boxes for each maintenance organisation, the RDS being programmed to address its alerts and scheduled messages to the relevant one for the maintenance organisation to which its client belongs. Differentiation between maintenance organisations and alerts and scheduled messages need not be by email address, however, it could also be by information in the email or an attachment or retrieved form the database.

A further option would be to have different addresses for different kinds of alert.

The central server builds up a large database, from messages from the RDS's, keyed into the web portal and transferred from the service management systems of the maintenance organisations. One use of this is to analyse and report on the fault history of a particular electronic device, device type, site, client, maintenance organisation etc. Such reports are accessed via the web portal.

While the system has been described with the remote diagnostic software 22 monitoring several electronic devices 12, 14, 16 etc. which software collects information about those devices and forwards it to the central server 50, it is equally possible to arrange the system so that each electronic device sends information about it directly to the central server. The provision of the RDS 22 means, however, that information can be conveniently batched before forwarding to the central server.

A further advantage of the system is that each maintenance organisation can have access (potentially at least) to all the data from all the devices, not just their own, held in database of the central server. This facilitates clients moving between service organisations and allows identification of trends over a larger group of devices.

1. A remote maintenance data system comprising a central server, the central server comprising:
a receiving means arranged in the central server to receive status information about a plurality of electronic devices that from time to time require maintenance, that status information being transmitted from the devices to the central server directly or via one or more intermediary devices, the transmission of the status information being initiated by the devices and/or the intermediary devices; and
a sending means arranged in the central server to send a message, based on the status information, to an entity relevant to a particular electronic device, that enables the entity to obtain from the central server status information about the device.

2. A remote maintenance data system as claimed in claim 1, further comprising an analysing means for analysing the received status information.

3. A remote maintenance data system as claimed in claim 2, wherein the analysing means determines, depending on the received status information, if a said message is to be sent to a relevant entity or not.

4. A remote maintenance data system as claimed in claim 2, wherein the analysing means determines, depending on the received status information, when a said message is to be sent to a relevant entity.

5. A remote maintenance data system as claimed in claim 2, wherein the analysing means determines, depending on the received status information, to which relevant entity the message is to be sent.

6. A remote maintenance data system as claimed in claim 2, wherein the analysing means determines, according to condition data, if a said message is to be sent to a relevant entity or not.

7. A remote maintenance data system as claimed in claim 2, wherein the analysing means generates the message.

8. A remote maintenance data system as claimed in claim 1, wherein the central server has access to a database for storing data, wherein status information received by the central server is stored in the database.

9. A remote maintenance data system as claimed in claim 8, wherein the analysing means has access to data stored in the database.

10. A remote maintenance data system as claimed in claim 1, wherein status information, sent to the central server, includes a first type of status information indicating the need of maintenance of at least one of the electronic devices and a second type of information about the usage of at least one of the electronic devices.

11. A remote maintenance data system as claimed in claim 1, wherein status information, sent to the central server, includes information for the identification of the electronic devices.

12. A remote maintenance data system as claimed in claim 1, wherein a said message contains at least part of the status information about a said particular electronic device.

13. A remote maintenance data system as claimed in claim 12 wherein the status information provided by the central server in the said message to the entity is supplemented with additional relevant data from a database accessible to the central server.

14. A remote maintenance data system as claimed in claim 1, wherein the entity has access to at least one service management computer system containing data about at least some of the devices about which the entity is sent the said messages.

15. A remote maintenance data system as claimed in claim 1, wherein at least part of the status information supplied by the central server is supplemented with additional relevant data from a database accessible to the central server.

16. A remote maintenance data system as claimed in claim 1, wherein the said message comprises a hypertext link, the central server comprises a web server, and the said web server is arranged to respond to the said link being activated to provide the said status information.

17. A remote maintenance data system as claimed in claim 1, wherein data provided by the central server to an entity, or the form of that data, depends on the entity.

18. A remote maintenance data system as claimed in claim 1, wherein the central sever is arranged to receive data from a service management computer system.

19. A remote maintenance data system as claimed in claim 18, wherein the data received from the service management computer system includes data about the devices serviced by the said service management system.

20. A remote maintenance data system as claimed in claim 1, wherein the central server is arranged to transmit data to a service management computer system.

21. A remote maintenance data system as claimed in claim 20, wherein the data transferred includes data about the usage of an electronic device.

22. A remote maintenance data system as claimed in claim 21, wherein data relating to the usage of an electronic device is transferred directly to at least one service management computer system, without requiring operator intervention.

23. A remote maintenance data system as claimed in claim 21, wherein said data about the usage of an electronic device is sent to said service management computer system in batches.

24. A remote maintenance data system as claimed in claim 23, wherein said data about the usage of an electronic device is sent to said service management computer system once a threshold condition has been met.

25. A remote maintenance data system as claimed in claim 1, wherein the central server comprises a mail server having different mailboxes for receiving status information from different electronic devices, or sets of devices.

26. A remote maintenance data system as claimed in claim 1, wherein the central server comprises a mail server having different mailboxes for receiving from an electronic device status information indicating that the device requires attention and for receiving status information regarding the usage of the device.

27. A remote maintenance data system as claimed in claim 1, wherein status information for a set of devices is relayed by a common unit to the central server.

28. A remote data maintenance system as claimed in claim 27, wherein the central server is arranged to provide a report of which electronic devices provide status information to the common unit.

29. A remote data maintenance system as claimed in claim 27, wherein the central server is arranged to provide a single report of status information about a plurality of the electronic devices that provide status information to the common unit.

30. A remote maintenance data system as claimed in claim 1, wherein the central server is arranged to provide a history of status information about a particular electronic device.

31. A remote maintenance data system as claimed in claim 1, wherein the central server is arranged to provide an analysis of faults or usage over a plurality of electronic devices.

32. A remote maintenance data system as claimed in claim 1, wherein the said entity is given access to status information relating to one or more electronic devices to which it is not relevant.

33. A remote maintenance data system as claimed in claim 1, wherein the system further comprises:
the said plurality of electronic devices, and
a plurality of different service management computer systems, the central server being arranged to send the said messages to users of those service management computer systems.

34. A remote maintenance data system comprising a central server, the central server comprising:
a receiver arranged in the central server to receive status information about a plurality of electronic devices that from time to time require maintenance, that status information being transmitted from the devices to the central server directly or via one or more intermediary devices, the transmission of the status information being initiated by the devices and/or the intermediary devices; and
a transmission module arranged in the central server to send a message, based on the status information, to an entity relevant to a particular electronic device, that enables the entity to obtain from the central server status information about the device.

35. A remote maintenance data system as claimed in claim 34, wherein the receiver is a mail server.

36. A remote maintenance data system as claimed in claim 34, wherein the transmission module is a mail server.

37. A remote maintenance data system comprising:
a central server arranged to receive status information about a plurality of electronic devices that from time to time require maintenance, that status information being transmitted from the devices to the central server directly or via one or more intermediary devices; and
a web server arranged to communicate with the central server,
wherein:
the central server is further arranged to send a message containing information based on the status information to an entity relevant to a particular electronic device, said message comprising a hypertext link; and
the said web server, having access to at least the status information relevant to the particular electronic device, is arranged to respond to the said link being activated to provide the said status information.

38. A remote maintenance data system as claimed in 37, wherein the central server or the web server comprises a means for analysing the received status information.

39. A remote maintenance data system as claimed in claim 37, wherein the central server or the web server has access to a database for storing data, wherein status information received by the server is stored in the database.

40. A remote maintenance data system as claimed in claim 39, wherein the analysing means has access to data stored in the database.

41. A method of interfacing a plurality of electronic devices that from time to time require maintenance, comprising:
transmitting status information from the device to a central server, directly or via one or more intermediary devices; and
transmitting a message, to an entity relevant to a particular electronic device, that enables the entity to obtain from the central server status information about the device,
wherein the transmission of the status information is initiated by the devices and/or the intermediary devices.

42. A method of interfacing as claimed in claim 41, wherein the central server comprises a means for analysing the received status information.

43. A method of interfacing as claimed in claim 42, wherein the analysing means determines, depending on the received status information, if a said message is to be sent to a relevant entity or not.

44. A method of interfacing as claimed in claim 42, wherein the analysing means determines, depending on the received status information, when a said message is to be sent to a relevant entity.

45. A method of interfacing as claimed in claim 42, wherein the analysing means determines, depending on the received status information, to which relevant entity the message is to be sent.

46. A method of interfacing as claimed in claim 42, wherein the analysing means determines, according to condition data, if a said message is to be sent to a relevant entity or not.

47. A method of interfacing as claimed in claim 42, wherein the analysing means generates the message.

48. A method of interfacing as claimed in claim 41, wherein the central server has access to a database for storing data, wherein status information received by the central server is stored in the database.

49. A method of interfacing as claimed in claim 48, wherein the analysing means has access to data stored in the database.

50. A method of interfacing as claimed in claim 41, wherein status information, sent to the central server, includes a first type of status information indicating the need of maintenance of at least one of the electronic devices and a second type of information about the usage of at least one of the electronic devices.

51. A method of interfacing as claimed in claim 41, wherein status information, sent to the central server, includes information for the identification of the electronic devices.

52. A method of interfacing as claimed in claim 41, wherein a said message contains at least part of the status information about a said particular electronic device.

53. A method of interfacing as claimed in claim 52, wherein the status information provided by the central server in the said message to the entity is supplemented with additional relevant data from a database accessible to the central server.

54. A method of interfacing as claimed in claim 41, wherein the entity has access to at least one service management computer system containing data about at least some of the devices about which the entity is sent the said messages.

55. A method of interfacing as claimed in claim 41, wherein at least part of the status information supplied by the central server is supplemented with additional relevant data from a database accessible to the central server.

56. A method of interfacing as claimed in claim 41, wherein the said message comprises a hypertext link, the central server comprises a web server, and the said web server is arranged to respond to the said link being activated to provide the said status information.

57. A method of interfacing as claimed in claim 41, wherein data provided by the central server to an entity, or the form of that data, depends on the entity.

58. A method of interfacing as claimed in claim 41, comprising transmitting data from a said entity to the central server.

59. A method of interfacing as claimed in claim 58, wherein the data transmitted includes data about the devices serviced by the said entity.

60. A method of interfacing as claimed in claim 41, comprising transmitting data from the central server to a said entity.

61. A method of interfacing as claimed in claim 60, wherein the data transmitted includes data about the usage of an electronic device.

62. A method of interfacing as claimed in claim 41, wherein the central sever is arranged to receive data from a service management computer system.

63. A method of interfacing as claimed in claim 62, wherein the data received from the service management computer system includes data about the devices serviced by the said service management system.

64. A method of interfacing as claimed in claim 41, wherein the central server is arranged to transmit data to a service management computer system.

65. A method of interfacing as claimed in claim 64, wherein the data transferred includes data about the usage of an electronic device.

66. A method of interfacing as claimed in claim 65, wherein data relating to the usage of an electronic device is transferred directly to at least one service management computer system, without requiring operator intervention.

67. A method of interfacing as claimed in claim 65 or claim 66, wherein said data about the usage of an electronic device is sent to said service management computer system in batches.

68. A method of interfacing as claimed in claim 67, wherein said data about the usage of an electronic device is sent to said service management computer system once a threshold condition has been met.

69. A method of interfacing as claimed in claim 41, wherein the transmitting of the status information from the devices to the central server is by email that is addressed differently for status information from different electronic devices.

70. A method of interfacing as claimed in claim 41, wherein the transmitting of the status information from the devices to the central server is by email that is addressed differently for indications that the device requires attention and for information regarding the usage of the device.

71. A method of interfacing as claimed in claim 41, wherein status information for a set of devices is relayed by a common unit to the central server.

72. A method of interfacing as claimed in claim 71, wherein the central server is arranged to provide a report of which electronic devices provide status information to the common unit.

73. A method of interfacing as claimed in claim 71, wherein the central server is arranged to provide a single report of status information about a plurality of the electronic devices that provide status information to the common unit.

74. A method of interfacing as claimed in claim 41, wherein the central server is arranged to provide a history of status information about a particular electronic device.

75. A method of interfacing as claimed in claim 41, wherein the central server is arranged to provide an analysis of faults or usage over a plurality of electronic devices.

76. A method of interfacing as claimed in claim 41, wherein the said entity is given access to status information relating to one or more electronic devices to which it is not relevant.

77. A method of interfacing a plurality of electronic devices that from time to time require maintenance comprising:
transmitting status information from the devices to a central server, directly or via one or more intermediary devices,
transmitting a message containing information based on said status information, to an entity relevant to a particular electronic device, said message comprising a hypertext link; and
providing a web server that has access to at least the status information relevant to the particular electronic device, said web server responding to the activation of the hypertext link to provide the said status information.

78. A method of interfacing of interfacing as claimed in claim 77, wherein the central server or the web server comprises a means for analysing the received status information

79. A method of interfacing as claimed in claim 78, wherein the central server or the web server has access to a database for storing data, wherein status information received by the server is stored in the database.

80. A method of interfacing as claimed in claim 79, wherein the analysing means has access to data stored in the database.

81. A method of interfacing as claimed in claim 77, wherein the transmission of status information is initiated by the said device or intermediary devices.
